(19) United States
(12) Patent Application Publication
(10) Pub. No.: US 2024/0019257 A1
(43) Pub. Date: Jan. 18, 2024

(54) System And Method Using Multilateration And Object Recognition For Vehicle Navigation

(71) Applicant: Neal C. Fairbanks, Livonia, MI (US)

(72) Inventor: Neal C. Fairbanks, Livonia, MI (US)

(21) Appl. No.: 18/221,459

(22) Filed: Jul. 13, 2023

Related U.S. Application Data
(60) Provisional application No. 63/388,773, filed on Jul. 13, 2022.

(51) Int. Cl. G01C 21/34; G06T 7/73; G06V 20/58; G06V 10/764

(52) U.S. Cl. CPC G01C 21/3461; G06T 7/73; G06V 20/58; G06V 10/764; G06T 2207/30252

(57) ABSTRACT

A system for providing navigational guidance through an environment is provided that includes a vehicle, a processing device, a memory, a transceiver module, a sensor module, and a camera system. The system determines a location of the vehicle by communicating with at least two external transmitting devices and determines the location of the vehicle by using multilateration. The system also utilizes the camera system to detect objects in the environment via object recognition and classifies the detected objects according to characteristics of the objects, as well as locating the object in the environment. The system utilizes the location of the vehicle and the detected objects for making navigation decisions.

### BACKGROUND

### 1. Field of the Invention

The subject invention generally relates to systems and methods for vehicle navigation based on environmental characteristics determined by multilateration and object recognition.

### 2. Description of Related Art

Ordinary vehicle navigation involves a driver taking in information from the environment around them and making decisions based on this information. In recent years, great strides have been taken toward automating the collection of environmental information as well as automating the decision making based on the environmental information. For example, autonomous driving has progressed to the point that more recent vehicles include features now known in the art such as Lane Keeping Assist, Adaptive Cruise Control, Automatic Emergency Braking, Lane Departure Warnings, Parking Assist, and many others. In the near future, autonomous vehicles may even be able to navigate from a first location to a second location entirely autonomously.

Today, autonomous navigation generally involves the use of sensors attached to the vehicle being navigated. These sensors tend to collect information within the line of sight of the sensors such that the vehicle can be described as having a line of sight itself. With that being said, a great deal of information may be beyond the line of sight of the vehicle. For example, an object (e.g., another vehicle) may be traveling at speed just around the corner of a building interposed between the vehicle and the object. Today's autonomous vehicles are unable to collect information beyond their own line of sight and thus cannot make decisions based on environmental information beyond this line of sight.

Although today's autonomous vehicles do not collect information beyond their own line of sight, these same vehicles tend to utilize certain technologies that operate separate from their own line of sight. For example, autonomous navigation often involves the usage of triangulation via GPS signals to determine the location of the vehicle relative to the environment. Triangulation most often involves satellites located far from the vehicle's location, however, some autonomous systems have started to incorporate signals from nearby objects (e.g., roadside units) in areas where satellite signals are weak and/or obstructed. However, these nearby objects are generally fixed in location and signals therefrom are tailored to the autonomous system. These autonomous systems make sense of the signals received from the nearby objects based on the fixed locations and the tailored nature of the signals. Therefore, these autonomous systems are unable to communicate with nearby objects that are not specifically designed to aid in autonomous vehicle navigation, such as smartphones and other devices that include internet-of-things (IoT) capabilities.

As such, there is a need in the art for a system which addresses the aforementioned challenges.

### SUMMARY

A system and a corresponding method are provided for providing navigational guidance to a vehicle in an environment. The system includes a vehicle, a processing device, a memory, a transceiver module, a sensor module, and a camera system. The environment may include an urban canyon. In order to navigate the vehicle, the system is configured to determine a location of the vehicle by communicating with at least two external transmitting devices located in the environment. The system is capable of determining the location of the vehicle by using multilateration. The system also utilizes the camera system to detect objects in the environment via object recognition. The camera system is able to classify the detected objects according to characteristics of the objects as well as locate the object in the environment. The system may make navigation decisions based on the location of the vehicle and the detected objects. The navigation decisions may be based on a combination of safety, driving, and convenience factors.

The transceiver module may include at least one of a radio-frequency (RF) transceiver, a cellular transceiver, a WiFi transceiver, a Bluetooth transceiver, a satellite navigation module, and an antenna. The sensor module may include at least one of a gyroscope, a compass, and an accelerometer.

The method includes various steps and processes for navigating the vehicle through the environment. The method includes locating the vehicle relative to the environment by utilizing the multilateration. The multilateration may include bilateration, and the vehicle may be located by communicating with two external transmitting devices. In other configurations, the multilateration may be performed with more than two external transmitting devices, such as with five external transmitting devices. The multilateration may further include detecting movement variables corresponding to the movement of the vehicle to more accurately determine the locating of the vehicle.

The multilateration method may include determining the location of the vehicle based on signals received from the external transmitting devices. The external transmitting devices may transmit signals containing location information such as latitude, longitude, altitude, as well the external device model number, manufacturer name, model/device name or type, owner name, etc. The location information may be stored locally on the memory and/or the transceiver module, and/or stored remotely so that the transceiver module may access it. Alternatively, or additionally, the external transmitting devices may transmit more than once where each signal has a different center frequency, and the transceiver module can receive and handle these different transmissions. The multilateration method may then determine the distances between the vehicle and each respective external device to locate the vehicle.

The method also includes using the camera system to detect objects located in the environment via an object recognition method. The object recognition method may include detecting an object in a line of sight of the camera system. After detecting the object, the method may include classifying the object according to its characteristics and locating the object according to it position relative to the camera system. The object recognition method may classify the detected objects as at least one of a moving object, a non-moving object, an obstruction, a navigation aid, and a commercial establishment. The objects may be classified according to their characteristics, including a color or shape of the object, text located on the object, and/or light located on or surrounding the object. Alternatively, or additionally, the objects may be recognized by using a known library of objects.

The method may include associating detected objects with the signals received by the transceiver module. The signals may include signals from other vehicles, IoT devices, RSUs, or other devices capable of communication with the transceiver module. In other words, the method may include expanding the line of sight of the system by combining information from the camera system with information from the transceiver module. The safety, driving, and convenience factors of the navigation decisions may be affected by the recognition of moving/non-moving objects, obstructions, navigation aids, and/or commercial establishments. The method may include recognizing the objects with at least one of the camera system and the transceiver module, or with a combination of the camera system and the transceiver module.

These and other configurations, features, and advantages of the present disclosure will be apparent to those skilled in the art. The present disclosure is not intended to be limited to or by these configurations, embodiments, features, and/or advantages.

### BRIEF DESCRIPTION OF THE DRAWINGS

Advantages of the present invention will be readily appreciated as the same becomes better understood by reference to the following detailed description when considered in connection with the accompanying drawings, wherein:

FIG. 1 is an exemplary block diagram of a system.

FIG. 2 is an electronic device in communication with a plurality of transmitting devices.

FIGS. 3A and 3B depict illustrative transmission circles for external transmitting devices and a vehicle including a transceiver module is at one of the two intersections of the circles.

FIG. 4 is a schematic view of a vehicle located in an urban environment and including the system.

FIG. 5 is an exemplary urban environment including a first vehicle and a second vehicle.

### DETAILED DESCRIPTION

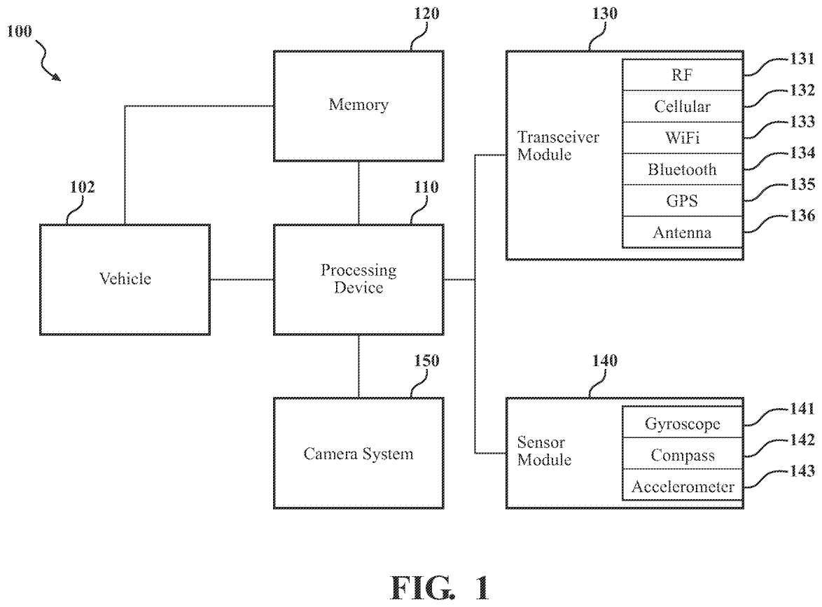

Referring to FIG. 1, a system 100 for navigating a vehicle 102 is provided. The system 100 includes a processing device 110, a memory 120, a transceiver module 130, a sensor module 140, and a camera system 150. It is to be appreciated that most, if not all vehicles 102, include processing devices 110 and memories 120 used in performing typical vehicle operations. The system 100 of the subject invention is capable of being executed on and/or operated with the typical processing devices 110 and memories 120 or with separate, specific systems for performing the subject method. The vehicle 102 is generally in electrical communication with the processing device 110 and the memory 120 as is well known to those having ordinary skill in the art. Similarly, the processing device 110 is in electrical communication with the memory 120, the transceiver module 130, the sensor module 140, and the camera system 150, as is well known to those having ordinary skill in the art.

The processing device 110 may be used in controlling the operation of the vehicle 102, the system 100 or any of the other components. The processing device 110 may be based on a processing device such as a microprocessing device and other suitable integrated circuits. While the processing device 110 is referred singularly, it is to be appreciated that one or more individual processing devices may be used in performing the subject method. The memory 120 include one or more different types of storage such as hard disk drive storage and memory. The memory may be non-volatile (e.g., flash memory or other electrically-programmable-read-only memory) or volatile memory (e.g., static or dynamic random-access-memory). With one suitable arrangement, the processing device 110 and the memory 120 may be used to run software on the electronic device, such as mapping applications (e.g., navigation applications for a vehicle or electronic device), email applications, media playback applications, operating system functions, software for capturing and processing images, software implementing functions associated with gathering and processing sensor data, software for issuing alerts and taking other actions when suitable criteria are satisfied, software that makes adjustments to display brightness and touch sensor functionality, etc. The operation of the processing device 110 and the memory 120 is well known to those of ordinary skill in the art, and the specifics details of such operation is not necessary for an understanding of the subject invention and is therefore not included.

The camera system 150 is able to provide a 360-degree view around the vehicle, which may be achieved using a plurality of cameras or a single camera that is able to provide a 360-degree view. The use of the camera system 150 is less expensive to provide inputs to the system 100 than other available technologies, such as light detection and ranging (Lidar) systems commonly in use. In one embodiment, there are eight (8) cameras located about the vehicle to produce the 360-degree view.

As the vehicle 102 moves through an environment, the transceiver module 130, the sensor module 140, and the camera system 150 may provide inputs to the processing device 110 for guiding the vehicle 102 processing device. The processing device 110 may make various calculations based on the inputs, and the memory 120 may be used to store instructions and/or the inputs. The memory 120 may be non-volatile (e.g., flash memory or other electrically-programmable-read-only memory) or volatile memory (e.g., static or dynamic random-access-memory).

In one example, the vehicle 102 may be an autonomous or semi-autonomous passenger vehicle configured to transport occupants and navigate the vehicle through an environment. In another example, the vehicle 102 may be a flying drone configured to deliver goods to customers. In either example, the environment may be an urban canyon (e.g., a highly populated city with tall buildings) which limits GPS signal propagation.

In order to support communication between the system 100 and different types or forms of external transmitting devices for navigation purposes, the transceiver module 130 may include one or more of the following components: a radio-frequency (RF) transceiver 131, a cellular transceiver 132, a WiFi transceiver 133, a Bluetooth transceiver 134, and a satellite navigation module (herein, “GPS module”) 135. It is to be appreciated that fewer than all of these components may be utilized depending upon the specific application. The RF transceiver 131 may support incoming and outgoing communication via radio waves (i.e., bidirectional), and the cellular transceiver 132 may support incoming/outgoing communication via cellular signals. The cellular signals can include, but are not limited to, global system for mobile communications (GSM), code division multiple access (CDMA), General Packet Radio Service (GPRS), 4G, 5G. Other communication protocols can also be supported, including other 802.11x communication protocols (e.g., WiMax), Enhanced Data GSM Environment (EDGE). The WiFi transceiver 133 allows the system 100 to communicate via WiFi signals, such as IEEE 802.11a, b, g, n, signals, or Wireless Access in Vehicular Environment (WAVE) signals. The Bluetooth transceiver 134 enables Bluetooth communication between the transceiver module 130 and external transmitting devices. And the GPS module 135 allows the transceiver module 130 to receive signals from the global positioning system (GPS) and/or alternative satellite systems (e.g., China's BeiDou, the EU's Galileo, Russia's GLONASS, India's NavIC, or Japan's QZSS). It is to be appreciated that various configurations and combinations of such circuitry may be used with the electronic device according to the subject invention, while still practicing the invention. For example, the WIFI transceiver 133 and the RF transceiver 131 may be a single transceiver.

The location of the system 100 may be determined via geolocation identification in mobile Heterogeneous Networks (HetNet) environments. In some embodiments, the electronic device may have connectivity to a transmitting device. Here, “connectivity” does not necessarily require that a wireless session be initiated between the transmitting device and the electronic device; instead, it may be sufficient that data (e.g., IP/WLAN packets) can be successfully transmitted from the electronic device to the transmitting device, or from the transmitting device to the electronic device. For example, if the electronic device is scanning for wireless networks and is able to detect a service set identifier (SSID) associated with a wireless local-area network facilitated by the transmitting device, the electronic device and the transmitting device may be said to have connectivity to each other. In such examples, the SSID may be used to generate the transmitting device connectivity notification.

The system 100 may also include an antenna 136. The antenna 136 may be included in the transceiver module 130. In certain embodiments, the antenna 136 may be a tunable antenna, which may also be referred to as a reconfigurable antenna or a self-structuring antenna. When the antenna 136 is tunable, it can modify dynamically its frequency properties in a controlled and reversible manner. It is to be appreciated that multiple antennas, each for a different frequency type, could be used in place of the antenna 136 that is tunable so long as the system 100 is able to switch between antennas to tune for a specific signal type and frequency. One type of self-structuring antenna may be obtained from Monarch Antenna, Inc. The tuning of the antenna 136 may also be performed with software.

The subject system 100 according to the subject invention may also utilize inputs from the sensor module 140 for navigation decisions. The sensor module 140 generally includes a gyroscope 141, a compass 142, and an accelerometer 143. Each of the gyroscope 141 and the accelerometer 143 are configured to determine movement associated with the vehicle 102, such as velocity and acceleration, while the compass 142 is configured to detect a heading (i.e., compass direction) of the vehicle 102 based on the Earth's magnetic poles. As further described below, the movement and/or heading of the vehicle 102 may be utilized in combination with the transceiver module 130 to locate the vehicle 102 in the environment. Other suitable sensors for determining movement variables and heading are contemplated.

The system 100 is configured to determine the location of the vehicle 102 in the environment. This determination may be based on a number of techniques, for example, multilateration techniques including triangulation via GPS or bilateration via wirelessly-communicating devices. GPS triangulation is highly accurate when the vehicle 102 is traveling in an open environment, however, bilateration is favored when the vehicle 102 is traveling in urban canyon environments where GPS signals are blocked and/or obstructed. Bilateration is possible with devices located within the urban canyon because it utilizes signals from devices within the environment. Other multilateration techniques are contemplated.

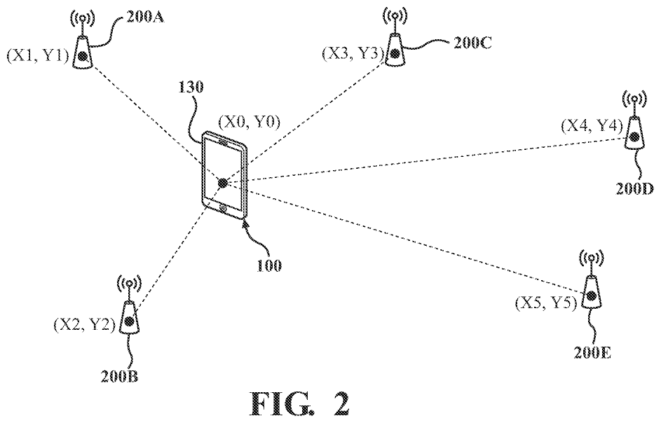

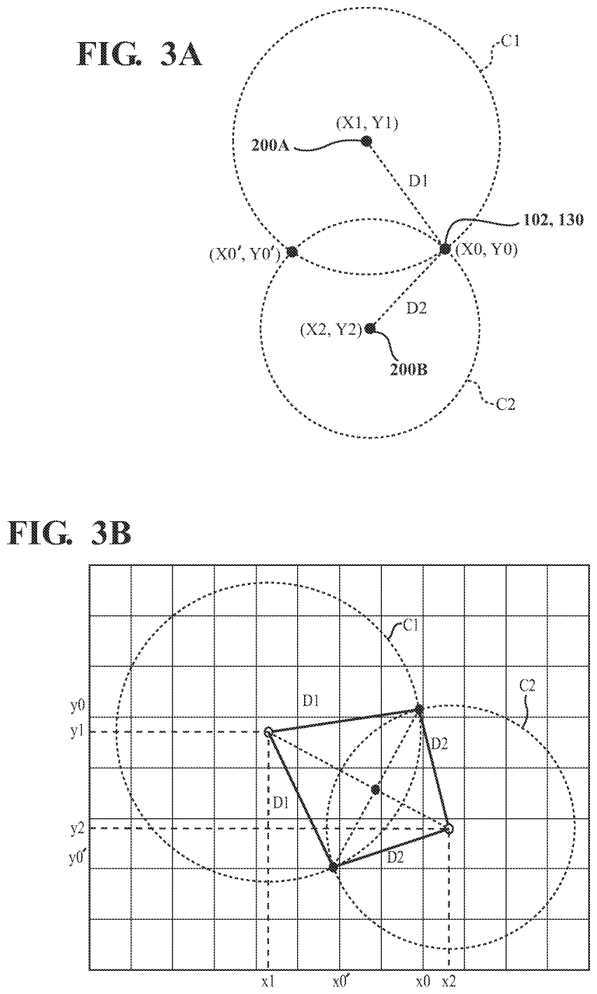

Referring to FIGS. 2-3B, an exemplary system 100 used in the bilateration method is provided. The bilateration method is performed to determine the location of the system 100, in this case in the vehicle 102, based on signals received from a plurality of external transmitting devices 200. The external transmitting devices 200 may be any device capable of sending and receiving signals to and from the transceiver module 130. For example, the external device 200 may include, but is not limited to, a computer, a router, a switch, a hub, a universal serial bus (USB) stick, a roadside unit (RSU), or any other device capable of receiving and transmitting data (e.g., Internet Protocol (IP) packets, wireless local-area network (WLAN) packets, etc.) or any other device that transmits signals that are connected to a Wide Area Network (WAN). The external transmitting devices 200 can include WLAN operating at different frequencies and using several wireless standards.

The external transmitting devices 200 transmit signals, or messages, that are received by the transceiver module 130. The type of signals being transmitted can vary widely, but may include Wi-Fi signals, cellular signals, Wireless Access in Vehicular Environment (WAVE) signals, and GPS signals. The WAVE signal supports communication of fast running vehicles and is configured with the Institute of Electrical and Electronics Engineers (IEEE) 802.11p and the IEEE 1609, generally in the 5.9 Ghz spectrum. The IEEE 1609.3 of the IEEE 1609 defines a network layer and a transport layer service, and the IEEE 1609.4 provides a multichannel operation. To take advantage of WAVE, the system 100 communicates with the RSU. RSUs may be installed on both sides of the road and at various locations along the roadway. In such an embodiment, the transceiver module 130 may operate as an onboard unit (OBU), the external device 200, or both depending on the particular location or application. When vehicle to vehicle (V2V) communication is established, one OBU is the transceiver module 130, while the other is the external device 200 or vice versa. When the vehicle to infrastructure (V2I) communication is established, the OBU is the transceiver module 130 and is communicating with the RSU as the external device 200. RSUs have an established location that is precisely known allowing the vehicle to determine its location relative to the RSUs.

For stationary external transmitting devices 200, the respective location information may be known and transmitted as part of the signal or available from public Wi-Fi location databases, such as SkyHook Wireless, Combain Positioning Service, LocationAPI.org by Unwired Labs, Mozilla Location Service, Mylnikov GEO, Navizon, WiGLE, amongst others. The location information can include latitude, longitude, altitude, as well the external device 200 model number, manufacturer name, model/device name or type, owner name, etc.

The external device 200 may be able to store transmitting device location coordinates. For example, the transmitting device location coordinates may be stored in a location configuration information (LCI) format which may include, without limitation, latitude, longitude, and/or altitude information. As another example, the transmitting device location coordinates may be stored in a civic format which may include, without limitation, door number, street address, suite number, city, state, country, zip code, etc. The location coordinates may be stored locally on the memory 120 and/or the transceiver module 130, and/or stored remotely so that the transceiver module 130 may access it.

In yet another embodiment, the external device 200 can transmit more than once where each signal has a different center frequency and the transceiver module 130 can receive and handle these different transmissions. For example, 802.11a and 802.11b use two different frequencies and if both the external device 200 and transceiver module 130 support 802.11a and 802.11b then using both provides better averaging. Yet another embodiment is for the external device 200 to transmit more than once where each signal uses a different wireless standard, such as WLAN and UWB. The transceiver module 130 supports these different wireless standards and more data is gathered, and location accuracy is improved through averaging. The transceiver module 130 may also receive a signal from the cellular network tower. The cell communication can include, for example, information identifying the cell tower. In some implementations, the cell communication can also include the latitude and longitude of the cell tower.

Referring to FIG. 2, the transceiver module 130 is shown in communication with a plurality of external transmitting devices 200. The plurality of external transmitting devices 200 may include a first external device 200A, a second external device 200B, a third external device 200C, a fourth external device 200D, and a fifth external device 200E. Although five devices are shown in FIG. 2, any plurality of external transmitting devices 200 may be used to determine the location of the vehicle 102 via multilateration. Further, although the multilateration described herein is primarily discussed in terms of bilateration by means of two external transmitting devices 200, the method may also be applied to multilateration by means of more than two external transmitting devices 200 (e.g., five external transmitting devices 200A-E).

The exemplary bilateration method comprises the step of obtaining a first location comprising coordinates of the vehicle 102. Still referring to FIG. 2, the transceiver module 130 receives a plurality of signals emitted from the external transmitting devices 200 within a vicinity of the transceiver module 130 with the antenna 136. Each of the external transmitting devices 200 may be transmitting the same or different signal types. A signal quality is determined for a first signal transmitted from a first external device 200A having a first signal type based on: A) signal propagation characteristics for the first external device 200A and B1) a received signal strength indicator (RSSI) or B2) a received signal power and a received signal gain for the first signal. It is to be appreciated that the transceiver module 130 may simultaneously receive the plurality of signals and may simultaneously or nearly simultaneously determine the signal quality for more than one signal.

The RSSI that is received may be provided as part of the signal and represents a measurement of the power present in the received signal. The RSSI is the relative signal strength and is typically in arbitrary units, whereas power is typically measured in decibels. If the RSSI is not provided, the transceiver module 130 may calculate the signal strength based on the received signal power and the received signal gain for the first signal or both. The transceiver module 130 may use the memory 120, processing device 110, and/or other circuitry to determine the signal strength from the power and gain of the received first signal as is well known to those skilled in such arts. Typically, when the transceiver module 130 is located a certain distance from the external device 200, the signal will have a certain RSSI or signal strength. The RSSI or signal strength fluctuates even though the transceiver module 130 remains in the same location as a result of numerous issues. Alternatively, the received channel power indicator (RCPI) may be received.

In order to determine the signal quality, the transceiver module 130 does not merely rely on RSSI or signal strength, but also uses the signal propagation characteristics associated with the first external device 200A. The signal from the first external device 200A may include the manufacturer of the device and the type of device or this information is retrievable based on the received signal. A device database is queried based on manufacturer and type of the first external device 200A to determine the actual signal propagation characteristics, which is often referred to as a signal propagation curve. The device database may be stored locally on the transceiver module 130 or memory 120, or stored remotely so that the transceiver module 130 may access it. From the device database, the signal propagation curve can be obtained and compared with the RSSI to determine whether the signal is of sufficient quality. Because the RSSI or signal strength fluctuates or wavers, the identification of the highest quality signal can be skewed. By combining the signal propagation characteristics with the RSSI or signal strength, the transceiver module 130 can control how the signal is received and can predict the fluctuations, which results in a more stable detection and higher signal quality.

Next, the first signal having the highest signal quality is designated for location determination such that the processing device 110 will utilize the first signal for determining a distance The signals may be used for a set time period, such as 2 seconds, before scanning for other higher quality signals. If necessary, the antenna 136 may be tuned for the first signal type and the first signal is received with the antenna 136. The first signal received with the antenna 136 is used to determine a distance D1 from the first external device 200A. The distance can be determined based on one or more of: a received signal power and a received signal gain for the first signal as received by the antenna 136, at least one of transmitted power and transmitted signal gain of the first signal for the first external device 200A, or location information associated with the first external device 200A identified by at least one of a media access control (MAC) address and an internet protocol (IP) address. It is to be appreciated that the term “one or more” does not require one of each of the elements to be present. For example, the distance may be determined by using only the received signal power and the received signal gain or by using only the transmitted power and transmitted signal gain of the first signal for the first external device 200A, if possible. Alternatively, the distance may be determined by using only the location information associated with the first external device 200A or the distance could be determined based on a combination of each.

The location information of the external device 200 may include the SSID and the MAC address of the external device 200. From the SSID or the MAC address, a signal strength for the first signal may be received at the transceiver module 130 based on the first external device 200A. The signal strength may be, for example, measured in Watts, Volts, dBm, dB, or like units. As discussed above, the signal strength can be RSSI or calculated from the power and gain. The accuracy of the location information may depend on the number of positions that have been entered into the database and on which databases are used.

Next, a signal quality for a second signal is determined from a second external device 200B. It is to be appreciated that the first and the second signals may be received simultaneously or near simultaneously. The transceiver module 130 may receive the signals 10 to 100 times a second and, as such, the determinations may be performed 10 times a second and up to 100 times a second. As faster data processing speeds are possible, the transceiver module 130 and/or the processing device 110 may process upwards of 1000 times a second if more accuracy is desired. The second signal may have a second signal type different than or the same as the first signal. The signal quality is based on the same factors used from the first signal, as discussed above, and applied to the second signal. The second signal having the next highest signal quality is designated for location determination. In other words, the processing device 110 will use the second signal with next highest signal quality to determining the distance.

If needed, the antenna 136 is tuned for the second signal type and the second signal is received with the antenna 136. A distance is determined from the second external device 200B based on one or more of: a received signal power and a received signal gain for the second signal as received by the antenna 136, transmitted power and transmitted signal gain of the second signal for the second external device 200B, or location information associated with the second external device 200B identified by at least one of a media access control (MAC) address and an internet protocol (IP) address. Determining the distance of the transceiver module 130 from the second external device 200B using the antenna 136 is the same as described above with respect to the first external device 200A. However, it is to be appreciated that determining the distance from the first and second external transmitting devices 200A, 200B may be different and may rely on different variables between the first and second signals.

Once the distances of the first and second external transmitting devices 200A, 200B are known from the respective first and second signals, the relative location between the transceiver module 130 (and thus the vehicle 102) and the respective first and second external transmitting devices 200A, 200B is ascertained and first and second transmission circles are developed based upon the distances. Next, points of intersection are determined where the first and second transmission circles intersect.

FIGS. 3A and 3B show illustrative transmission circles for the transmitting devices and the transceiver module 130 is at one of the two intersections of the circles. The location coordinate for the transceiver module 130 can be narrowed down to one of two intersection coordinates, (X0, Y0) and (X0′, Y0′), which are the points of intersection of circles C1 and C2 defined by using the location coordinates (X1, Y1) and (X2, Y2) as centers of the circles C1 and C2, respectively, and device distances D1 and D2 as radii of the circles C1 and C2, respectively. The first external device 200A is at location coordinates (X1, Y1) and the second external device 200B is at location coordinates (X2, Y2). The transceiver module 130 is a distance D1 from the first external device 200A and a distance D2 from the second external device 200B. In this example, each location is defined in terms of two-dimensional Cartesian coordinates (X and Y). However, it is to be understood that any spatial location coordinate system may be used with dimensionality ranging from a single dimension (e.g., (X); (θ); etc.) to three dimensions (e.g., (X, Y, Z); (R, θ, φ); etc.). The Z coordinate in the X, Y, Z coordinates may correspond to the vertical location (height) of the external transmitting devices 200. The external transmitting devices 200 may be positioned at each level in a multilevel roadway, the transceiver module 130 may be provided with information on which level the vehicle 102 is located on (either from information such as a transmitted Z location from the external transmitting devices 200 or transmitted roadway level information).

Since the vehicle 102 (i.e., the transceiver module 130) may be located at either of the two points of intersection, the method determines which of the two points of intersection is reliable. In order to determine which intersection is reliable, the intersection coordinates are compared to the first (or previous) location coordinates to determine if the intersection coordinates are feasible. This is based on detecting movement variables of the vehicle 102 to a subsequent location from the first location. For example, with the sensor module 140, the movement variables may include velocity and direction, which are provided by at least one or more of the accelerometers 143 or the gyroscope 141. In such an embodiment, if the current direction of the vehicle 102 is known, then the current direction can be compared to the intersection coordinates to determine if either are reliable and/or if one is more reliable than the other.

If the velocity of the vehicle 102 is known, then the previous location and the velocity can be used to compare the intersection coordinates and determine if either are reliable and/or if one is more reliable than the other. If the distance is too great, then the current location may be disregarded. If the distance is not too great, then the current location is reliable. In determining whether the distance is feasible, the velocity of the vehicle 102 can be evaluated in combination with the previous location. One query is whether the current position is possible given the known previous location and velocity. For example, if the distance from the previous location is calculated one second later and is 500 feet away, and the vehicle 102 was traveling 55 mph (about 80 feet per second), then the current location is not reliable. However, if the distance from the previous location is calculated one second later and is 75 feet away, and the vehicle 102 was traveling 55 mph (about 80 feet per second), then the current location may be considered reliable.

The bilateration method may also utilize a threshold based on a fixed velocity or speed when evaluating the distance from the previous location. For example, the previous location could be evaluated at speeds of 5 mph, 10 mph, 15 mph and at the actual speed. If the current location is reliable based on such evaluation, then it is stored and updated. The threshold could also be dependent upon the actual speed if known. For instance, if the vehicle 102 is or was moving at 55 mph, then the threshold could be measured in 5 mph intervals, such as at 45, 50, 60, 65 mph for the evaluation. Since the measurements are occurring at a very rapid pace, 10 to 100 times a second, the vehicle 102 could only change speed or velocity so much. Therefore, the threshold may have smaller intervals, such as 1 mph.

Once the intersection is determined to be reliable, the new coordinates are generated for the transceiver module 130 and the vehicle 102 corresponding to the reliable intersection. The new coordinates are stored in the transceiver module 130 and/or the memory 120 and the location of the vehicle 102 is updated and may be used as an input for navigation of the vehicle.

Additionally, if the first location, velocity, and direction of the vehicle 102 is known, the system 100 can determine an estimated location based on this information and a tolerance associated with the estimated location can be established. Depending on the velocity or the desired accuracy, the tolerance may be a few inches to a few feet. The estimated location can be compared to the current location to determine if the current location is within the tolerance and storing locations within the tolerance. If one of the intersection coordinates are within the tolerance, then this intersection coordinate is reliable and can be recorded as the new coordinate and current location of the vehicle 102.

In one particular application, the vehicle 102 may be in motion and, thus, the method includes the step of retrieving a current direction of the vehicle 102 and comparing the current direction to an initial direction. If the current direction and initial direction are the same, then the method is restarted. Said differently, in this example, the vehicle 102 has not moved so the method continues to monitor for motion. In order to precisely locate the vehicle 102 in a field when the vehicle 102 is moving, the current direction of the vehicle 102 is retrieved and compared to an initial direction to determine whether the current location is within specified boundaries. If the current direction is outside of the specified boundaries, the method is restarted.

In order to ensure precision and accuracy of the location, the transceiver module 130 monitors for signals having a higher signal quality than either of the first and second signals. The monitoring may be accomplished by continuously scanning for signals or scanning at predetermined time intervals. The transceiver module 130 may initiate a new search for a new plurality of signals and re-measure signal quality after expiration of the predetermined time and selecting the two signals with the highest signal quality. For example, the first and second signals may be used for the predetermined amount of time before the transceiver module 130 checks for a different signal having a higher signal quality. If the first and second signals remain the highest quality, then the location determination continues with these signals. The antenna 136 may also re-tune its configuration to maintain the first and second signal as the highest quality while the vehicle 102 is in motion.

If a new, third signal is detected and it is determined that the signal quality of the third signal from the third external device 200C having a third signal type is of a higher quality, then the signal with the lowest signal quality is dropped and the third signal is designated for location determination. The determination of the signal quality of the third signal proceeds in the same manner as described above for the first and second signals.

Similarly to the first and second signals discussed above, once the third signal is selected, the antenna 136 may be tuned for the third signal type, if needed, and the third signal is received with the antenna 136. The received third signal is then used to determine the distance the vehicle 102 is from the third external device 200C as described above for the first and second signals, including developing a third transmission circle, determining points of intersection between the third transmission circle and the remaining one of the first and second transmission circles, and determining which of the two points of intersection is reliable. New coordinates may be generated for the vehicle 102 based upon the distances from the first and third external transmitting devices 200A, 200C, which are recorded as a current location of the vehicle 102 and provided for navigational guidance. An exemplary system and method for determining the location of a device/vehicle using bilateration may be found in U.S. Pat. No. 10,743,141, which is hereby incorporated by reference in its entirety.

The multilateration (e.g., bilateration) method described herein is especially advantageous when multiple vehicles, for example a first vehicle 102A and a second vehicle 102B, are on the road and in communication with one another via V2V communication. More specifically, the V2V communication can be used to (1) locate the first vehicle 102A by using the second vehicle 102B as one of the external transmitting devices 200, and (2) communicate the location of one of the first and second vehicles 102A, 102B to the other of the first and second vehicles 102A, 102B.

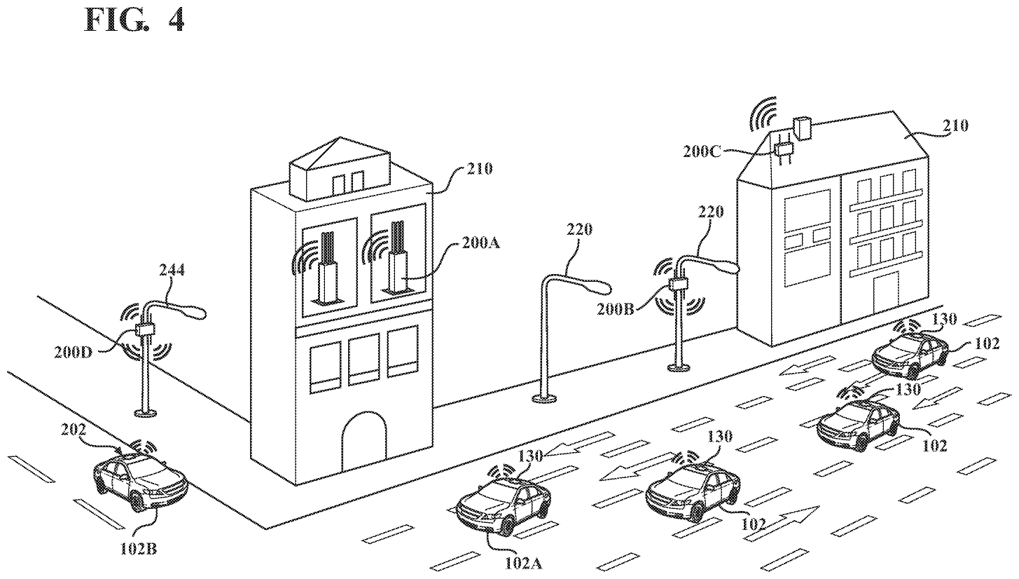

Referring to FIG. 4, an urban environment is shown wherein the first and second vehicles 102A, 102B are navigating through the environment using the system 100. For example, as shown in FIG. 4, the first external device 200A is shown as an IoT device present in a building 210, the second external device 200B is an RSU attached to a light post 244, and the third external device 200C is a router present in/on another building 210. In addition, multiple vehicles 102 are shown driving on the road. The first and second vehicles 102A, 102B are shown approaching an intersection—the first vehicle 102A and the second vehicle 102B being separated by the building 210 such that the second vehicle 102B is outside the line of sight of the first vehicle 102A.

By utilizing the bilateration method described herein, and without being limited to bilateration, the first vehicle 102A may be informed that the second vehicle 102B is behind the building. In one example, the second vehicle 102B may make use of the first and second external transmitting devices 200A, 200B shown in FIG. 4 to determine the distance and the location of the second vehicle 102B via the bilateration method described herein. After the second vehicle 102B determines its own location, the second vehicle 102B may communicate with the first vehicle 102A to inform the first vehicle 102A of the location of the second vehicle 102B. Once the first vehicle 102A knows the location of the second vehicle 102B, the system 100 of the first vehicle 102A, and more particularly, the processing device 110, may make navigation decisions. In the same example, the second vehicle 102B may include its velocity in the communication sent to the first vehicle 102A, and the first vehicle 102A can decide whether to continue through the intersection based on the location and velocity of the second vehicle 102B. This type of decision, in which the system 100 takes in environmental information to help navigate the vehicle 102, is hereby referred to as a “navigation decision” or “navigational guidance.”

The system 100 may also make use of the camera system 150 when making navigation decisions. For example, as further described below, the system 100 may utilize object recognition in order to determine what types of objects 202 are captured in the image by the camera system 150 that are in the line of sight of the vehicle 102. “Line of sight” refers to a field of view that is an area which the camera system 150 can image. In the embodiment where the camera system 150 is a 360-degree camera, the line of sight would extend around the entirety of the vehicle and the camera system 150 can image the entire view and capture objects therein. Alternatively, a plurality of cameras, such as eight, can make up the camera system 150 provide a 360-degree views. By understanding what types of objects are present in the environment, as well as where other vehicles are located and/or are moving to/from, the system 100 may make more complex navigation decisions. The navigation decisions may include several factors such as safety factors, driving factors, and/or convenience factors. While there may be other factors involved in vehicle navigation, such factors could be implemented by those having ordinary skill in the art based on the teachings of the subject invention and therefore are not addressed further.

The system 100 may recognize the objects 202 captured by the camera system 150 based on a library of objects. While the invention is described as the system 100 recognized the object 202, it is to be appreciated that the camera system 150 may include more than cameras, such as processors or memory, and the camera system 150 may perform the object recognition itself without departing from the subject invention. The library of objects may be a custom or proprietary object library, or may use a publicly-available library of objects/shapes such as the OpenCV library developed by Intel. In either case, the system 100 may analyze specific characteristics of the object(s) 202 in the images in order to recognize the object(s) 202. For example, these specific characteristics could be a color or shape of the object 202, text located on the object 202, and light located on or surrounding the object 202. Other aspects are contemplated.

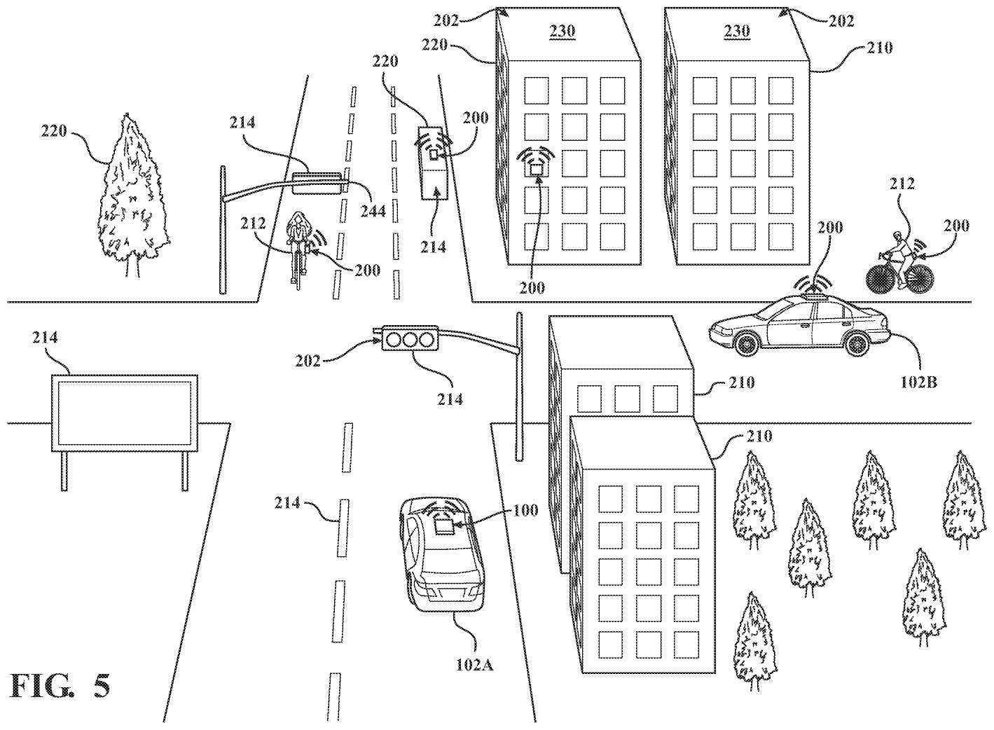

Referring to FIG. 5, an exemplary urban environment including the first vehicle 102A and the second vehicle 102B is shown. It is to be appreciated that the objects 202 may include vehicles 102. The exemplary urban environment further includes buildings 210, bicyclists 212, navigation aids 214, obstructions 220, and commercial establishments 230 among other moving and non-moving objects 202. In order to make navigation decisions, the objects 202 in the field of view of the camera system 150 may be detected and the system 100 may determine what the object 202 includes based on object recognition. Object recognition can be based on color, shapes, sizes, and the like as is known to those skilled in the art. More specifically, the system 100 may classify objects 202 into classes based on characteristics of the objects 202, and subsequently make navigation decisions based on the object 202 and its classification. As one example, once the camera system 150 recognizes the object 202, accurate distance measurements for the object 202 from the system 100 can be calculated using comparative perception and a determination can be made whether the distance of the object 202 is changing using a moving parallax. When the one or more cameras detect the object 202, the distance measurement is quickly made and then it is determined whether the distance has changed representing that the object 202 is moving. For example, if there are two cameras, and each camera identifies and recognizes the object 202 in its respective field of view, these images are used to determine the distance and subsequent images are used to determine movement. As is described in more detail below, the system 100 may optionally include both objects 202 in line of sight of the vehicle 102 as captured by the camera system 150, as well as objects 202 detected while carrying out the bilateration (or multilateration) method for its navigational guidance.

In one example, the system 100 may classify the object 202 as one of a moving object and a non-moving object. It is to be appreciated that the object 202 may be simultaneously identified as the object 202 and the external device 200. Moving objects, such as bicyclists 212, introduce more uncertainty into the decision-making process of the system 100 and may thus be handled different from non-moving objects, such as buildings 210. During navigation of the vehicle 102, the system 100 may observe bicyclists 212 and buildings 210 via the camera system 150 and make decisions based on a combination of the location and presence of the buildings 210 and the bicyclists 212. For example, as shown in FIG. 5, the first vehicle 102A may see multiple moving and non-moving objects 202. In the figures, a plurality of buildings 210 are present along the road and the bicyclist 212 is present in the opposite lane of the road from the first vehicle 102A. As these objects 202 are recognized by the camera system 150, the system 100 may make navigation decisions based on the moving bicyclist 212 and non-moving building 210.

In another example, the system 100 may classify the object 202 captured by the camera system 150 as an obstruction 220. To decide whether the object 202 is an obstruction 220, the system 100 may consider whether the object 202 will obstruct the vehicle 102 during planned navigation or even unplanned navigation. In FIG. 5, various obstructions 220 are present and in view of the first vehicle 102A. These obstructions 220 include a tree on the side of the road, one of the buildings, and an exemplary object on the side of the road up ahead of the first vehicle 102A. Other objects 202 that may be considered obstructions 220 may include the second vehicle 102B, the bicyclists 212, other objects on the roadway, faults in the roadway itself, and/or other objects that may obstruct the path of the vehicle 102 being navigated by the vehicle 102. As the obstructions 220 are visible by the camera system 150 and recognized by the system 100, the system 100 may make navigation decisions based on these obstructions 220.

In yet another example, the system 100 may classify the object 202 according to whether the object 202 is a navigation aid 214. The navigation aids 214 generally include objects 202 present in the environment which an ordinary driver would use to navigate said environment. In other words, objects 202 that would inform an ordinary driver of upcoming travel path characteristics, such as lane lines, road junctions, detours, stop signs, traffic lights, traffic cones/barrels, and/or other similar objects 202. FIG. 5 includes a number of navigation aids 214, such as lane lines, a traffic light, an informational sign, and an exemplary object 202 present in the roadway which could represent, for example, a traffic cone. Although modern navigation technology often includes a detailed map of the environment, some even being updated in near-real time as road are closed, these navigation technologies do not contain enough information to navigate the vehicle 102. One modern navigation technology is Google Maps, which is continuously updated with information in an attempt to better inform occupants of changes to their travel path. Even so, these technologies do not capture changes to the travel path of the vehicle 102 in real time such that the system 100 can depend on these technologies to make any and all navigation decisions. As such, the camera system 150 may be utilized by the system 100 to recognize navigation aids 214 that could change the roadway from the perspective of the vehicle 102. Something as ubiquitous as a traffic light is ever-changing and must be observed by the system 100 in order to decide whether to continue through a junction of the roadway. Thus, as the navigation aids 214 are recognized by the camera system 150, the system 100 may make navigation decisions based on these navigation aids 214.

In yet another example, the system 100 may classify the object 202 according to whether the object 202 is a commercial establishment 230. Exemplary commercial establishments 230 include places of business that may be of interest to an occupant of the vehicle 102. For example, the commercial establishment 230 may be a fast-food restaurant. In such an example, as the camera system 150 captures an image of the object 202 and the system 100 recognizes at least one object 202 as at least one commercial establishment 230, the system 100 may offer altered travel paths to the occupant if the occupant would like to visit any one or more of the establishments 230 on the way to their destination. Other navigation decisions are contemplated.

As mentioned above, as the camera system 150 observes objects 202 in the environment and the system 100 recognizes the objects 202, the objects 202 may be utilized by the system 100, including with the processing device 110, to make more informed navigation decisions. More specifically, the safety, driving, and convenience factors of the navigation decisions may be affected by the recognition of moving/non-moving objects 202, obstructions 220, navigation aids 214, commercial establishments 230, and/or other objects 202 not explicitly mentioned herein. It is to be appreciated that either the camera system 150 may identify, classify, and locate the object 202 or the processing device 110 may identify, classify, and locate the external device 200 without deviating from the subject invention. For example, the processing device 110 may receive the images from the camera system 150 and analyze the image for objects 202. If text is detected in the image, the processing device 110 may identify the object 202 therein and then, relying on known and standard text sizes, the processing device 110 can determine a distance the object 202 is from the system 100. In one example, as the vehicle 102 approaches a stop sign, the “STOP” text on the stop sign is a required size and the system 100 is able to calculate its distance based on the measured size in the image. Similarly, as the vehicle 102 continues to approach the stop sign, the “STOP” text would become larger in the image, indicating the location of the vehicle 102 has changed. In addition to the size of text, the height of certain objects 202 will change as the objects 202 gets closer or farther away and with changing perspective. The system 100 can use the changing size and perspective to determine how the position of the object 202 relative to the vehicle 102 is changing for making navigation decision.

The safety factors included in the navigation decisions may involve the safety of at least one of the drivers of the vehicle 102 and/or other living things in the environment such as the bicyclist 212. For example, the bicyclist 212 may be traveling along the roadway adjacent to the vehicle 102 and one safety factor could be a distance between the vehicle 102 and the bicyclist 212. Other safety factors may include elements of navigation such as a speed of the vehicle 102. Since it may take the vehicle 102 longer to slow to a stop when travelling at high speed, the speed of the vehicle 102 may be lowered in response to recognizing specific types of objects 202. As another example, the camera system 150 observe a fault in the roadway, such as a pothole, and the system 100 recognizes this as an obstruction and slows the vehicle 102 in response such that the vehicle 102 is not damaged or otherwise affected by travelling over the pothole.

The driving factors included in the navigation decisions may involve anything which could affect the travel path of the vehicle 102. For example, referring back to the example with the bicyclist 212, the system 100 may determine that the vehicle 102 would have to slow down to stay in a lane of traffic behind the bicyclist 212. In order to more efficiently get the vehicle 102 to the destination, the system 100 may cause the vehicle 102 to pass the bicyclist 212. Since safety factors are also included in the navigation decisions, the system 100 may also cause the vehicle 102 to pass the bicyclist 212 at a certain speed. Other driving factors and combinational navigation decisions are contemplated.

The convenience factors included in the navigation decisions may involve optional decisions offered to the occupant of the vehicle 102. Optional decisions are generally related to offering goods and/or services to the occupant of the vehicle 102. For example, the system 100 may determine that the recognized commercial establishment 230 sells food—in response, the system may offer to change the travel route of the vehicle 102 in order to stop at the commercial establishment 230 for food.

In some examples, the system 100 makes navigation decisions based on a combination of the safety, driving, and convenience factors. Further, since safety, driving, and convenience factors involve the recognition of different classifications of objects 202 in the environment, any combination of moving/non-moving objects 202, obstructions 220, navigation aids 214, commercial establishments 230, and/or other objects 202 not explicitly mentioned herein may be considered by the system 100 when making navigation decisions.

The system 100 may also utilize the information collected by the processing device 110 and/or transceiver module 130 during the multilateration method as described above. More specifically, the system 100 may expand the line of sight of the vehicle 102 by determining the type and location of the external transmitting devices 200 communicating with the transceiver module 130. In other words, instead of relying on the camera system 150 to inform the system 100 of the objects 202 in the environment, the system 100 may also rely on the transceiver module 130 for a similar purpose. Alternatively, the system 100 may combine the identification of the objects 202 detected by the camera system 150 with the external device 200 location information provided by the transceiver module 130 and associate such inputs to make more precise navigational decisions. As one example, but not limited hereto, if a pedestrian is an identifiable object in the image, and if the pedestrian is also carrying a cellular phone as an external device 200, then the system 100 would both rely on the image detection and the signal detection to locate the pedestrian and provide such input for navigation guidance.

Still referring to FIG. 5, each type of object 202 in the environment may be considered as the external device 200 for purposes of the subject method presuming that such external devices 200 are present. As the system 100 communicates with the external transmitting devices 200 in order to locate the vehicle 102, the system 100 may also attempt to recognize the object 202 associated with the external device 200. For example, the bicyclist 212 may be outside the view of the camera system 150 of the first vehicle 102A, but the bicyclist 212 may be carrying a smartphone, which his detected as the transmitting device 200 detected by the transceiver module 130. Although the system 100 may not have line of sight of the bicyclist 212 via the camera system 150, the system 100 may instead know the approximate location of the bicyclist 212 via the transceiver module 130. Further, the system 100 may determine the velocity of the bicyclist 212 based on the signal from the smartphone associated with the bicyclist 212. Once the system 100 knows the location and velocity of the external device 200, and thus the bicyclist 212, the system 100 may make navigation decisions based on this data. In such an example, the system 100 may determine that the bicyclist 212 is travelling at a certain rate of speed and is likely to cross in front of the first vehicle 102A in a precarious manner. In response, the system 100 may slow down or even attempt to alert the bicyclist 212 of the presence of the first vehicle 102A. Alternatively, if the bicyclist 212 is within the line of sight of the second vehicle 102B, the system 100 of the second vehicle 102B may communicate the presence of the bicyclist 212 to the first vehicle 102A. At the same time, the first vehicle 102A may detect the external device of the 212 using the transceiver module 130 and combine such inputs to be able to “see” the bicyclist 212 that is not within the line of sight of the first vehicle 102A.

In another example, the transceiver module 130 may pick up signals from external transmitting devices 200 located in the commercial establishment 230. The signals from such an external device 200 may include details on the type of product/service offered by the commercial establishment 230. As such, the system 100 may offer a change in travel path to the occupant of the vehicle 102 such that the occupant may visit the commercial establishment 230.

In yet another example, the obstruction 220 may be outfitted with an IoT device that may act as the external device 200. As will be appreciated from FIG. 5, the exemplary obstruction discussed in reference to the first vehicle 102A may not otherwise be in view of the camera system 150 of the second vehicle 102B. Instead, the transceiver module 130 may receive signals from the external device 200 located proximate the obstruction 220 which include the location of the device 200 and the type of object 202 in which the device 200 is located. Here, the external device 200 is located in the obstruction 220 in the roadway. As the transceiver module 130 receives the signals from the external device 200, the system 100 may be informed that the obstruction 220 will affect the travel path of the second vehicle 102B if a right turn is taken. As such, the system 100 may make navigation decisions based on signals received by the transceiver module 130.

Further, the system 100 may make navigation decisions based on a combination of objects 202 recognized by the system of the first vehicle 102A and objects 202 recognized by other vehicles, such as the second vehicle 102B. As will be appreciated from the figures, the second vehicle 102B may have a different line of sight, and/or receive different signals via its own transceiver module 130 and may thus recognize objects 202 or detect the location of objects 202 not recognized by the first vehicle 102A. In order to take advantage of this information, the system 100 of the first vehicle 102A may communicate with the second vehicle 102B.

Once again referring to FIG. 5, the first and second vehicles 102A, 102B may be in communication with one another. The camera system 150 of the first vehicle 102A may capture one of the bicyclists 212, multiple navigation aids 214, a number of buildings 210, and the exemplary obstruction 220. The camera system 150 of the second vehicle 102B, on the other hand, captures a different bicyclist 212, the commercial establishment 230, and only one of the navigation aids 214 (in this case, the second vehicle 102B can only see the traffic light). By communicating with the second vehicle 102B, the first vehicle 102A can also know the location of the other bicyclist 212 and the commercial establishment 230, both of which may be outside the line of sight of the first vehicle 102A but in the line of sight of the second vehicle 102B. Similarly for the second vehicle 102B, by communicating with the first vehicle 102A, the second vehicle 102B may now know the location of the other navigation aid 214 (in this case an informational sign and lane lines), the other bicyclist 212, and the exemplary obstruction 220. As such, each vehicle 102A, 102B may make more informed navigation decisions by utilizing the information received from the other vehicle 102A, 102B.

In a similar manner to the information from the camera systems 150 of the vehicles 102A, 102B above, the external transmitting devices 200 detected by each vehicle's 102A, 102B transceiver modules 130 may be communicated from one vehicle 102A, 102B to the other 102A, 102B. For example, the first vehicle 102A may be outside the range of the external device 200 located in the commercial establishment 230 while the second vehicle 102B may be within such a range. By communicating with the first vehicle 102A, the second vehicle 102B may inform the first vehicle 102A of the presence of the commercial establishment 230. In another example, the first vehicle 102A may be outside the range of the external device 200 located with the bicyclist 212 outside the view of the first vehicle 102A while the second vehicle 102B may be within such a range. By communicating with the first vehicle 102A, the second vehicle 102B may inform the first vehicle 102A of the presence and/or trajectory of the bicyclist 212. Again, the vehicles 102A, 102B may make more informed navigation decisions by communicating with the other vehicle 102A, 102B.

As another example, the camera system 150 of the first vehicle 102A may capture the obstruction 220 present in the roadway and the system 100 determines it is best to change lanes to avoid the obstruction 220. The first vehicle 102A may then inform the second vehicle 102B of the obstruction 220 and that avoiding the lane with the obstruction 220 is best. As a result, the second vehicle 102B may make navigation decisions based on this information from the first vehicle 102A. If the travel path of the second vehicle 102B initially included turning right at the intersection and would have included turning into the lane with the obstruction 220, the system 100 of the second vehicle 102B could alter the travel path to instead turn into the lane adjacent to the obstructed lane without needing to recognize the obstruction 220 itself. Instead, the system 100 of the second vehicle 102B may rely on information received from the system 100 of the first vehicle 102A.

The systems 100 of the first and second vehicles 102A, 102B may also communicate with one another in an attempt to make a coordinated navigation decision by relying on inputs from the camera system 150 and communicating via the transceiver modules 130. For example, the first and second vehicles 102A, 102B may be travelling side-by-side along the roadway and separated by a single lane line. If the system 100 of the first vehicle 102A recognizes an obstruction 220 with the camera system 150 present in the lane by which the first vehicle 102A is travelling, the system 100 may determine that changing lanes is appropriate. If, at the same time, the second vehicle 102B is side-by-side with the first vehicle 102A, the first vehicle 102A would ordinarily not be able to move over into the second vehicle's 102B lane. However, the system 100 of the first vehicle 102A could communicate the intended lane change to the system 100 of the second vehicle 102B via the transceiver module 130 and request that the second vehicle 102B change lanes to accommodate the first vehicle 102A. As long as the second vehicle 102B is able to change lanes, the first vehicle 102A may avoid the obstruction 220 by moving into the lane previously occupied by the second vehicle 102B. This lane change may be coordinated such that the first and second vehicles 102A, 102B change lanes at approximately the same time.

The navigation decisions as influenced by the system 100 as described above may also apply to semi-autonomous navigation. Semi-autonomous navigation includes features such as Lane Keeping Assist, Adaptive Cruise Control, Automatic Emergency Braking, Lane Departure Warnings, Parking Assist, and many others. As information is taken in by the system via the transceiver module 130 and the camera system 150, these features may be enabled, disabled, or altogether modified.

In a first example, Lane Keeping Assist is modified by the objects 202 recognized in the environment. The system 100 may recognize that the exemplary obstruction 220 is located in the travel path of the vehicle 102, and Lane Keeping Assist may be modified/disabled to allow a driver to move the vehicle 102 out of a lane in order to avoid the obstruction 220. Similarly, the vehicle 102 may recognize that the exemplary obstruction 220 is located in the travel path of the vehicle 102 while at the same time recognize that the bicyclist 212 is located on the other side of the lane line. Instead of modifying Lane Keeping Assist to allow the driver to steer the vehicle 102 around the obstruction 220, the system 100 may instead cause the vehicle 102 to maintain its lane and to slow down. Once the bicyclist 212 is determined to have passed the vehicle 102, the system 100 may modify the Lane Keeping Assist to allow the driver to move the vehicle 102 out of the lane in order to avoid the obstruction 220. The Lane Departure Warnings feature may also be affected in a similar manner such that warnings are not sounded if the driver is causing the vehicle 102 to avoid the obstruction 220.

Although the above description and the figures assume that the vehicle 102 is a passenger vehicle, the vehicle 102 may be any device capable of moving itself—such as any land-based vehicle, airborne vehicle, or seafaring vessel. More specifically, one of the examples above refer to the travel path of the vehicle 102 as a roadway, however, it is further contemplated that the vehicle 102 may travel along other travel paths other than the roadway shown in the figures. In one such example, the vehicle 102 is an airborne drone (e.g., for delivering packages) and the obstructions may instead apply to the three-dimensional space through which the drone is flying. Other vehicle types and respective travel paths are contemplated.

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

What is claimed is:

1. A system for providing navigational guidance to a vehicle, said system comprising:
a transceiver module comprising an antenna for transmitting and receiving a plurality of signals to and from a plurality of transmitting devices within a vicinity thereof;
a camera system comprising at least one camera for capturing images within a field of view around the vehicle;
a processing device determining a signal quality for the plurality of signals received by said transceiver module based on A) signal propagation characteristics comprising transmitting device information including one or more of manufacturer and type of transmitting device for each of the plurality of transmitting devices and B1) a received signal strength indicator or B2) a received signal power and a received signal gain;
said processing device designating at least two of the plurality of signals with a highest signal quality and determining a distance that said transceiver module is from the transmitting devices using the two highest signal quality signals;
said processing device analyzing said images captured by said camera system and identifying objects present therein, classifying the type of the object, and locating the object relative to said system; and
said processing device performing navigation decisions based on the distance of the transmitting devices from said system and the classification and location of the object identified in said field of view.

2. A system as set forth in claim 1 wherein said processing device further analyzes said images and determines a distance of the object from said system.

3. A system as set forth in claim 2 wherein said processing device identifies the object based on at least one of color or shape of the object, or text present on the object.

4. A system as set forth in claim 3 wherein said processing device determines whether said object is a moving object, a non-moving object, an obstruction, a navigation aid, or a commercial establishment within the field of view of said camera system.

5. A system as set forth in claim 2 wherein said camera system includes more than one camera capturing the object in multiple images of one instance for determining a distance of the object.

6. A system as set forth in claim 2 wherein said processing device utilizes object recognition to identify the object.

7. A system as set forth in claim 1 wherein said processing device further determines the signal propagation characteristics using a signal propagation curve based on the specific transmitting device information for the transmitting device and said processing device utilizes fluctuations of the signal defined by the signal propagation curve to determine said highest signal quality.

8. A system as set forth in claim 1 wherein said processing device associates the transmitting device with the object to enhance the location and distance determination of the object from said system.

9. A system as set forth in claim 1 further comprising a sensor module including at least one of a gyroscope, a compass or an accelerometer for providing inputs to said processing device for performing navigation decisions.

10. A system as set forth in claim 9 wherein the processing device further receives velocity and heading inputs associated with movement of said system from a previous location to add the navigation decisions of said system.

11. A system as set forth in claim 1 wherein said antenna is further defined as a tunable antenna that is reconfigurable to detect different signal types.

12. A system as set forth in claim 1 wherein said camera system is further defined as providing a 360-degree field of view about said vehicle.

13. A system as set forth in claim 12 wherein said camera system includes at least eight cameras capturing images about said vehicle.

14. A method of providing navigational guidance to a vehicle having a processing device, a transceiver module, and a camera system, said method comprising the steps of:
receiving, with the transceiver module, a plurality of signals from a plurality of transmitting devices within a vicinity of the vehicle;
capturing images, with the camera system within a field of view of the camera system, around the vehicle;
determining, with the processing device, a signal quality for the plurality of signals received by the transceiver module based on A) signal propagation characteristics comprising transmitting device information including one or more of manufacturer and type of transmitting device for each of the plurality of transmitting devices and B1) a received signal strength indicator or B2) a received signal power and a received signal gain;
designating, with the processing device, at least two of the plurality of signals with a highest signal quality and determining a distance that the transceiver module is from the transmitting devices using the two highest signal quality signals;
analyzing, with the processing device, the images captured by the camera system and identifying objects present therein, classifying the type of the object, and locating the object relative to the vehicle; and
performing, with the processing device, navigation decisions based on the distance of the transmitting devices from the vehicle and the classification and location of the object identified in the field of view.

15. A method as set forth in claim 14 wherein the signal propagation characteristics is further defined as retrieving a signal propagation curve associated with the transmitting device and utilizing the signal propagation curve to compare the received signal with either 1) the received signal strength indicator or the received signal power and 2) the received signal gain for identifying signals with the highest signal quality for location determination.

16. A method as set forth in claim 15 wherein the step of determining the distance from the transmitting device is further defined as using location information associated with each of the plurality of transmitting devices identified by at least one of a media access control (MAC) address and an internet protocol (IP) address.

17. A method as set forth in claim 15 wherein the step of identifying the object is further defined as identifying the object based on at least one of color or shape of the object, or text present on the object.

18. A method as set forth in claim 15 wherein the step of identifying the object is further defined as determining whether the object is a moving object, a non-moving object, an obstruction, a navigation aid, or a commercial establishment within the field of view of the camera system.

19. A method as set forth in claim 18 wherein the processing device utilizes object recognition to identify the object.

20. A method as set forth in claim 14 further comprising the step of associating the transmitting device with the object to enhance the location and distance determination of the object from the system.
